(19) United States
(12) Patent Application Publication
(10) Pub. No.: US 2016/0358360 A1
(43) Pub. Date: Dec. 8, 2016

(54) SYSTEMS AND METHODS FOR GENERATING A COMPOSITE IMAGE BY ADJUSTING A TRANSPARENCY PARAMETER OF EACH OF A PLURALITY OF IMAGES

(71) Applicant: Central Michigan University, Mount Pleasant, MI (US)

(72) Inventors: Harold Allen Wildey, Mount Pleasant, MI (US); Anthony Morelli, Mount Pleasant, MI (US); Ryan Soulard, Macomb Twp., MI (US)

(21) Appl. No.: 15/172,981

(22) Filed: Jun. 3, 2016

Related U.S. Application Data
(60) Provisional application No. 62/171,421, filed on Jun. 5, 2015.

(51) Int. Cl. G06T 11/60; G06T 3/40; G06K 9/00; G06T 3/60

(52) U.S. Cl. CPC G06T 11/60; G06T 3/60; G06T 3/40; G06K 9/00288; G06K 2009/00328

(57) ABSTRACT

Methods and systems for generating a composite image. One method includes receiving a plurality of images and selecting a base image from the plurality of images, wherein the base image includes a base object. The method also includes generating a stack of images by layering a first image included in the plurality of images on top of the base image, the first image including a first object, aligning the first object with the base object, and adjusting a transparency parameter of at least one of the first image and the base image to make the base image viewable through the first image. The method further includes combining the base image and the first image to generate the composite image, wherein the composite image represents a view of the stack of images from a top of the stack of images to the base image.

### RELATED APPLICATIONS

This application claims priority to U.S. Provisional Application No. 62/171,421, filed Jun. 5, 2015, the entire content of which is incorporated by reference herein.

### FIELD

Embodiments of the invention relate to systems and methods for generating a composite image from a plurality of images.

### BACKGROUND

Social media collects a large number of images. Many of these images are “selfies,” which is a portrait taken by the subject of the portrait. Front-facing cameras on mobile phones and other computing devices (e.g., smart phones, smart watches, tablet computers etc.) make it easy for individuals to take selfies and upload selfies to social media.

### SUMMARY

Embodiments of the invention provide automated systems and methods for creating a merged or composite image from a plurality of images. One system may include a software application executable by an electronic processor included in a computing device, such as a smart phone, tablet computer, or a server. Thus, by executing the software application, the electronic processor is configured to receive a plurality of images (e.g., automatically retrieved from one or more social media websites or other image sources, manually selected by a user through a graphical user interface, or a combination thereof). The plurality of images may include portrait images of one or more subjects. The electronic processor is also configured to create a stack of images using the plurality of images, wherein the stack of images includes a base image. To create the stack of images, a first image from the plurality of images is stacked or layered on the base image. The first image is scaled, translated (re-positioned), and rotated to align a subject displayed in the first image (or a portion thereof) with a subject displayed in the base image. The transparency of the first image, the base image, or both the first image and the base image is adjusted such that portions of the base image are viewable through the first image. The first image and the base image are then combined to create a composite image. This process may be repeated by stacking another image from the plurality of images onto the created composite image. Alternatively, the plurality of images may be stacked before performing the transparency adjustment.

For example, one embodiment provides a method of generating a composite image. The method includes receiving, with an electronic processor, a plurality of images. The method also includes selecting, with the electronic processor, a base image from the plurality of images, wherein the base image includes a base object. In addition, the method includes generating, with the electronic processor, a stack of images by layering a first image included in the plurality of images on top of the base image wherein the first image includes a first object, aligning, with the electronic processor, the first object with the base object, and adjusting, with the electronic processor a transparency parameter of at least one of the first image and the base image to make the base image viewable through the first image. The method also includes combining, with the electronic processor, the base image and the first image to generate the composite image. The composite image represents a view of the stack of images from a top of the stack of images to the base image.

Another embodiment provides an image processing system. The image processing system includes an electronic processor. The electronic processor is configured to receive a plurality of images, receive a base image including a base object, stack each of the plurality of images on top of the base image to generate a stack of images, align an object included in each of the plurality of images with the base object, adjust a transparency parameter of each of the plurality of images to make the base image viewable through each of the plurality of images, and combine the base image and the plurality of images to generate a composite image. The composite image represents a view of the stack of images from a top of the stack of images to the base image.

Other aspects of the invention will become apparent by consideration of the detailed description and accompanying drawings.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments described herein, including various principles and advantages of those embodiments.

FIG. 1 schematically illustrates an image processing system according to some embodiments.

FIG. 2 is a flowchart illustrating a method of generating a composite image performed by the image processing system of FIG. 1 according to some embodiments.

FIG. 3 illustrates four example images used to generate a composite image using the method of FIG. 2.

FIGS. 4A-B illustrate eight example images used to generate a composite image using the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and may include electrical connections or couplings, whether direct or indirect. Also, electronic communications and notifications may be performed using any known means including direct connections, wireless connections, etc.

It should also be noted that a plurality of hardware and software based devices, as well as a plurality of different structural components may be utilized to implement the embodiments described herein. In addition, it should be understood that embodiments described herein may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, electronic based aspects of the invention may be implemented in software (e.g., stored on non-transitory computer-readable medium) executable by one or more processors. As such, it should be noted that a plurality of hardware and software based devices, as well as a plurality of different structural components may be utilized to implement embodiments of the invention. For example, “mobile device” and “computing device” as used in the specification may include one or more electronic processors, one or more memory modules including non-transitory computer-readable medium, one or more input/output interfaces, and various connections (e.g., a system bus) connecting the components.

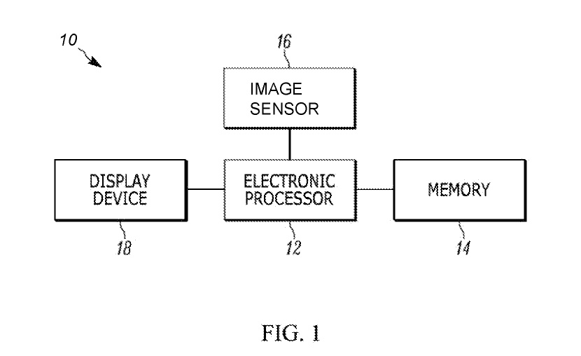

As noted above, embodiments provide automated systems and methods for generating a composite image from a plurality of images, such as portraits (e.g., selfies). For example, FIG. 1 schematically illustrates an image processing system 10 according to some embodiments. The image processing system 10 includes an electronic processor 12 (e.g., a microprocessor, application-specific integrated circuit (“ASIC”), or other suitable electronic device), a memory 14, an image sensor 16 (e.g., a digital still or video camera), and a display device 18. In some embodiments, the image processing system 10 includes additional, fewer, or different components. For example, in some embodiments, the image processing system 10 includes multiple electronic processors, memories, display devices, or combinations thereof. Also, in some embodiments, the image processing system 10 as described in the present application may perform additional functionality than the image generation functionality described in the present application.

The memory 14 includes non-transitory, computer-readable memory, including, for example, read only memory (“ROM”), random access memory (“RAM”), or combinations thereof. The memory 14 stores program instructions (e.g., one or more software applications) and images. The electronic processor 12 is configured to retrieve instructions from the memory 14 and execute, among other things, the instructions to perform image processing, including the methods described herein. The display device 18 is an output device that presents visual information. The display device 18 may include may include a light-emitting diode (“LED”) display, a liquid crystal display, a touchscreen, and the like.

In some embodiments, the electronic processor 12, the image sensor 16, and the display device 18 are included in a single computing device (e.g., within a common housing), such as a laptop computer, tablet computer, desktop computer, smart telephone, smart television, smart watch or other wearable, or another suitable computing device. In these embodiments, the electronic processor 12 executes a software application (e.g., a “mobile application” or “app”) that is locally stored in the memory 14 of the computing device to perform the methods described herein. For example, the electronic processor 12 may execute the software application to access and process data (e.g., images) stored in the memory 14. Alternatively or in addition, the electronic processor 12 may execute the software application to access data (e.g., images) stored external to the computing device (e.g., on a server accessible over a communication network, a disk drive, a memory card, etc.). The electronic processor 12 may output the results of processing the accessed data (i.e., a composite image) to the display device 18 included in the computing device.

In other embodiments, the electronic processor 12, the image sensor 16, the memory 14, or a combination thereof may be included in one or more separate devices. For example, in some embodiments, the image sensor 16 may be included in a smart telephone configured to transmit an image captured by the image sensor 16 to a server including the memory 14 over a wired or wireless communication network or connection. In this configuration, the electronic processor 12 may be included in the server or another device that communicates with the server over a wired or wireless network or connection. For example, in some embodiments, the electronic processor 12 may be included in the server and may execute a software application that is locally stored on the server to access and process data as described herein. In particular, the electronic processor 12 may execute the software application on the server, which a user may access through a software application, such as a browser application or a mobile application) executed by a computing device of the user. Accordingly, functionality provided by the image processing system 10 as described below may be distributed between a computing device of a user and a server remote from the computing device. For example, software a user may execute a software application (e.g., a mobile app) on his or her personal computing device to communicate with another software application executed by an electronic processor included in a remote server.

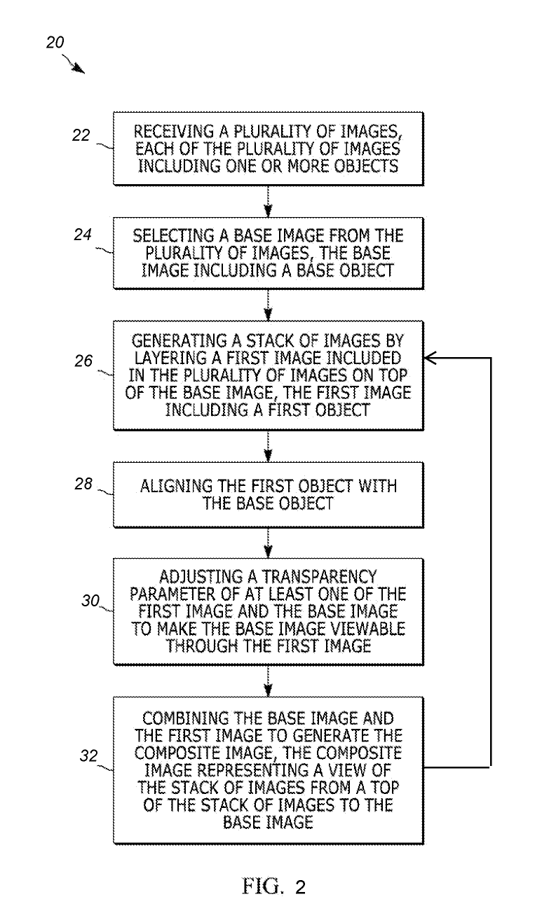

Regardless of the configuration of the image processing system 10, the image processing system 10 is configured to generate a composite image from a plurality of images. For example, FIG. 2 is a flow chart illustrating a method 20 of generating a composite image performed by the image processing system 10 (i.e., the electronic processor 12 executing instructions) according to some embodiments. As illustrated in FIG. 2, the method includes receiving, with the electronic processor 12, a plurality of images, wherein each image in the plurality of images includes one or more objects (at block 22). In one example, an object may be a subject's face. In another example, the object may be a building, a landmark, or a particular structure. In some embodiments, the electronic processor 12 receives the plurality of images, or a portion thereof, from the memory 14. Alternatively or in addition, the electronic processor 12 may initially retrieve the plurality of images, or a portion thereof, from additional memories local to or remote from the electronic processor 12. When a retrieved image is not locally stored (e.g., in the memory 14), the electronic processor 12 may locally store a copy of the retrieved image for later processing.

In some embodiments, the electronic processor 12 is configured to receive the plurality of images as a manual selection from a user. For example, the electronic processor 12 may be configured to generate a user interface (e.g., a graphical user interface (“GUI”)) that allows a user to select or designate images from one or more image sources, one or more images, or a combination thereof. Alternatively or in addition, the electronic processor 12 may be configured to automatically access images stored in one or more predefined image sources, such as a user's social media account or computer-readable media included in the user's computing device.

Also, in some embodiments, the electronic processor 12 is configured to automatically process images (e.g., selected manually or automatically) to identify whether an image meets particular requirements. For example, the electronic processor 12 may be configured to automatically determine whether a candidate image for the plurality of images includes a subject (e.g., using facial recognition techniques or other image categorizing techniques). When the candidate image does not include the subject, the electronic processor 12 may be configured to discard the candidate image, generate an alert to a user, or a combination thereof. In particular, when the electronic processor 12 is configured to automatically select the plurality of images, the electronic processor 12 may be configured to process candidate images stored in an image source to determine whether any of the candidate images are portraits and, optionally, whether any of the candidate images are portraits of a particular subject. When a candidate image is a portrait of the specified subject, the electronic processor 12 may include the candidate image to the plurality of images. Alternatively or in addition, the electronic processor 12 may be configured to display candidate images to a user within a user interface and allow the user to approve or reject each candidate image.

Alternatively or in addition, the electronic processor 12 may be configured to use metadata associated with a candidate image to determine whether to include the candidate image in the plurality of images. For example, the electronic processor 12 may determine whether to include a candidate image in the plurality of images depending on whether a particular subject is tagged or other identified in the candidate image based on metadata associated with the candidate image.

As illustrated in FIG. 2, the method 20 also includes selecting, with the electronic processor 12, a base image from the plurality of images (at block 24). The base image is the image that images included in the plurality of images are aligned to. For example, in some embodiments, the base image includes a base object, such as a face of a subject, and, as described in more detail below, objects included in the plurality of images are aligned with the base object.

In some embodiments, the electronic processor 12 is configured to prompt a user to select the base image from the plurality of images. In other embodiments, the electronic processor 12 is configured to automatically select the base image. In some embodiments, the electronic processor 12 automatically selects the base image randomly. In other embodiments, the electronic processor 12 may automatically select the base image based on metadata associated with each of the images in the plurality of images. For example, the electronic processor 12 may be configured to select the base image from the plurality of images based on a timestamp associated with each of the images in the plurality of images (e.g., to select the image from the plurality of images having the earliest timestamp).

In some embodiments, when the electronic processor 12 automatically selects a base image, the electronic processor 12 is configured to display the selected base image to the user through a user interface for approval or rejection. Also, in some embodiments, the electronic processor 12 is configured to allow a user to manipulate a base image by scaling, rotating, or positioning the base image (e.g., as displayed on the display device 18). In some embodiments, the base image is selected (e.g., manually or automatically) before the plurality of images are received or selected. For example, in some embodiments, the electronic processor 12 may be configured to use a manually-selected base image to automatically select the plurality of images to include candidate images that include the same subject as in the base image.

As illustrated in FIG. 2, the method 20 also includes generating, with the electronic processor 12, a stack of images by layering a first image included in the plurality of images on top of the base image (at block 26). Each image included in the plurality of images may include one or more objects that include or match the base object. Accordingly, the first image layered on the base image may include a first image that includes or matches the base object. Thus, the stack of images includes the base image as the bottom image in the stack and the layered images as the top images in the stack.

The method 20 also includes aligning, with the electronic processor 12, the first object with the base object (at block 28). For example, the electronic processor 12 may be configured to determine one or more dimensions of the first object (e.g., a width, height, rotation), determine corresponding dimensions for the base object, and adjust the first image to modify the dimensions of the first object to match the dimension of the base object. In particular, the electronic processor 12 may define a rectangle around the first object (e.g., a subject's face), define a rectangle around the base object (e.g., a subject's face), and adjusting the first image to modify the dimension of the rectangle around the first object (e.g., position, rotation, size, or a combination thereof) to match the dimensions of the rectangle around the base object.

Alternatively or in addition, the electronic processor 12 aligns the first object with the base object by aligning one or more facial features of the first object with corresponding facial features of the base object. In particular, the electronic processor 12 may be configured to determine a location of one or two eyes included in the base object (e.g., a center position between a subject's eyes or of each eye), determine a location of one or two eyes included in the first object (e.g., a center position between a subject's eyes or of each eye), and adjust the first image, the base image, or both to cause the location of the eyes included in the first object to align with the location of the eyes included in the base image (i.e., be positioned on the same horizontal plane). A consistent distance between the eyes may also be applied to the first image, the base image, or both to aid alignment of the images.

Similarly, in some embodiments, the electronic processor 12 may be configured to create a feature set table that includes the location and sizes of a plurality of features included in the base image (e.g., a plurality of facial features, a plurality of dark areas, a plurality of light areas, or a combination thereof). Accordingly, the electronic processor 12 may be configured to determine the location and sizes of the same plurality of features in the first image and modify the first image to match the location and sizes of the plurality of features in the first image to the plurality of features in the base image. Thus, the electronic processor 12 may be configured to align one or more discrete sections of the first image with one or more discrete sections of the base image (i.e., align one or more objects between the first image and the second image).

Also, in some embodiments, the electronic processor 12 is configured to determine the location or size of a particular feature included in the base image by determining one or more coordinates of particular features included in the base image. In some embodiments, the coordinates are pixel locations based on the original size of the base image and are defined relative to the upper left corner of the base image. These pixel locations, however, may have no or little relevance to the actual display of an image due to resolution capabilities of the display device displaying the images and how the image is displayed given its size. Accordingly, the electronic processor 12 may be configured to convert the pixel locations to a real-world coordinate system based on the display device displaying the images (e.g., the display device 18). These converted coordinates represent the size, position, and rotation of a feature (e.g., a subject's face) included in the base image as displayed on a particular display device. Thus, the electronic processor 12 may use the real-world coordinate system to compare the locations and sizes of features in the base image with the locations and sizes of features in the first image to adjust the images accordingly to provide a matching location and size.

To perform the alignment, the electronic processor 12 rotates the first image, resizes or scales the first image, re-positions the first image with respect to the base image, or a combination thereof. Also, in some embodiments, the electronic processor 12 may be configured to rotate the base image, resize or scale the base image, re-position the base image with respect to the first image, or a combination thereof rather than or in addition to modifying the first image. It should be understood that the electronic processor 12 may perform the rotation, scaling, and re-positioning of the images in various orders and sequences. For example, the electronic processor 12 may rotate an image, scale the image, and then re-position the image or may re-position an image, scale the image, and then rotate the image. Similarly, in some embodiments, the electronic processor 12 may rotate an image, scale an image, and rotate the image again. In some embodiments, the electronic processor 12 is configured to rotate images only on a two-dimensional plane and not in three-dimensional space. For example, in some embodiments, the electronic processor 12 does not convert profile images to front-facing images. However when a subject's head is leaning to one side or the other, the electronic processor 12 may be configured to rotate the image such that the rotation of the head matches that of the base image.

As illustrated in FIG. 2, the method 20 also includes adjusting, with the electronic processor 12, a transparency parameter of at least one of the first image and the base image to make the base image viewable through the first image (at block 30). The transparency parameter for an image impacts how much data from images positioned below the image in the stack is viewable through the image. In some embodiments, the less transparent an image is the more influence the image has on a resulting composite image.

In some embodiments, the electronic processor 12 is configured to assign a transparency parameter to each image included in the stack. The transparency parameter may be the same or may be different for all or some of the images. The transparency parameter may be applied to an image globally (i.e., across the entire image). However, in some embodiments, the transparency parameter may be applied locally (i.e., to less than the entire image).

In some embodiments, the electronic processor 12 adjusts a transparency parameter based on a manually-specified adjustment received from a user. In other embodiments, the electronic processor 12 adjusts a transparency parameter of an image based on a position of the image within the stack of images. In other embodiments, the electronic processor 12 adjusts a transparency parameter based on a number of images included in the stack of images. In yet another embodiment, the electronic processor 12 adjusts a transparency parameter based on a characteristic of an image. Some examples of such characteristic include brightness, sharpness, contrast, or a combination thereof.

In some embodiments, the electronic processor 12 randomly assigns each image in the stack a transparency parameter. For example, the electronic processor 12 may be configured to use a pseudo random number generator that selects transparency parameters based on various parameters, such as the number of images in the stack, an average brightness, sharpness, contrast, etc. of the images in the stack or the base image, etc. Alternatively, the electronic processor 12 may be configured to use a random number generator. For example, the electronic processor 12 may be configured to generate a user interface that includes a button or other selection mechanism that allows a user to initiate a random assignment of transparency parameters (e.g., initiate or seed the random number generator). After the user selects the button, the electronic processor 12 iterates through the stack of images and assigns a random transparency parameter to each image. In some embodiments, the electronic processor 12 generates a preview of the composite image generated based on a generated random number that is displayed to a user with in a user interface. When the user is not satisfied with the composite image, a user may re-select the button described above to generate a second random number using the random number generator (e.g., re-initiate the random number generator), which the electronic processor 12 uses to re-adjust the transparency parameter thereby generating a new version of the composite image. It should be understood that, in some embodiments, the electronic processor 12 is configured to randomly assign transparency parameters without requiring that a user select a button or other selection mechanism. Similarly, the electronic processor 12 may be configured to automatically determine whether a new random number should be generated to improve a resulting composite image (e.g., by analyzing characteristics of the composite image and comparing the characteristics to one or more thresholds).

Alternatively or in addition, the electronic processor 12 may be configured to define a transparency curve for the stack of images. The transparency curve may plot a transparency parameter for an image based on the image's position within the stack. For example, the x-axis for the curve may indicate a vertical order of images within the stack (e.g., with the far left of the axis representing a bottom of the stack and the far right of the axis representing a top of the stack), and the y-axis for the curve may indicate a transparency parameter. Accordingly, in some embodiments, the electronic processor 12 allows a user to select or draw a transparency curve for a stack (e.g., through a user interface). When a user selects or draws a flat line, the electronic processor 12 may be configured to assign each image in the stack the same transparency parameter. Alternatively, when a user selects or draws a line that curves upward (e.g., from a lower left to an upper right), the electronic processor 12 may be configured to make the images at the top of the stack more transparent than the images at the bottom of the stack.

In some embodiments, the electronic processor 12 may access one or more predetermined transparency curves that may be automatically applied or selected by a user to a stack of images. Also, in some embodiments, a user may use the electronic processor 12 to create additional transparency curves. Furthermore, in some embodiments, a user may share transparency curves with other users and, optionally, base images corresponding to the transparency curves. A user may assign a title to a created transparency curve. In some embodiments, the curve may be named for a subject included in the base image associated with the curve or a creator of the curve. As an example, a user may create a “LeBron James” transparency curve. The user may then distribute this curve to other users (e.g., with a picture of LeBron James to use as a base image for a stack). A user may use the distributed curve to apply the curve to their own stack of images through the electronic processor 12, which may include the designated base image (e.g., to provide a composite image generated from the designated base image and the designated transparency curve). Sharing transparency curves allows users to generate composite images with similar characteristics. For example, users may share and compare composite images generated using the “LeBron James” transparency curve and the corresponding common base image.

It should be understood that the transparency parameter assigned by the electronic processor 12 (automatically or in response to a user selection) may be specified as an amount of transparency (e.g., a percentage of total transparency) or an amount of opacity (e.g., a percentage of total opacity). Also, it should be understood that in some embodiments, the electronic processor 12 performs the transparency adjustment in a piece-meal fashion as images are added to the stack. For example, after an image is aligned to the stack, the electronic processor 12 may adjust the transparency of one or more images in the stack before the next image is aligned and added to the stack. Alternatively, the electronic processor 12 may be configured to adjust the transparency parameters after the stack is complete.

After the electronic processor 12 adjusts the transparency parameter, the electronic processor 12 combines the base image and the first image to generate a composite image (at block 32). The composite image represents a view of the stack of images from a top of the stack of images to the base image.

As illustrated in FIG. 2, the electronic processor 12 iterates through each image included in the plurality of images and adds each image to the stake of images (performing the alignment and transparency adjustment as described above) to match an object included in each image with the base object (e.g., as represented in the previously-generated composite image). Accordingly, after the electronic processor 12 adds each of the plurality of images to the stacks, the electronic processor 12 generates a composite image that represents a view of the stack of images including the plurality of images as viewed from the top of the stack to the base image.

In some embodiments, the electronic processor 12 processes each image included in the plurality of images individually as part of adding an image to the stack. When the electronic processor 12 determines that an object matching the base object is not included in a particular image, the electronic processor 12 may alert a user. Alternatively or in addition, the electronic processor 12 may discard the image and continue processing the remaining images. It should be understood that in some embodiments, the electronic processor 12 is configured to use facial recognition techniques provided by a separate software application. For example, the electronic processor 12 may be configured to pass images to a facial recognition server configured to process a received image and return coordinates as described above. Also, in some embodiments, one or more of the images received by the electronic processor 12 for processing includes the coordinates described above (e.g., as part of the image's metadata). For example, in some embodiments, an image may be associated with metadata that includes information about the subjects in the image and each subject's location within the image.

After the electronic processor 12 generates a composite image, the electronic processor 12 may display the composite image to a user (e.g., on the display device 18) for review. A user may save, print, or transmit (e.g., as or included in an e-mail message or included in a post to a social media network) the composite image as desired. In some embodiments, a user may also re-initiate (e.g., by selecting the button described above) the transparency parameter assignment to cause the electronic processor 12 to randomly assign new transparency parameters to the stack of images and generate a new composite image. Accordingly, the user may repeatedly generate different representations until the user is satisfied with the resulting composite image.

In some embodiments, the electronic processor 12 may also be configured to perform this process automatically. For example, upon creating a composite image, the electronic processor 12 may be configured to compare characteristics of the composite image to one or more thresholds or other benchmarks. When the parameters to not satisfy particular thresholds or benchmarks, the electronic processor 12 may automatically re-assign random transparency parameters to generate a new composite image.

Similarly, in some embodiments, the electronic processor 12 may be configured to change the order of the stack to improve the resulting composite image (e.g., randomly, based on the brightness, sharpness, contrast, etc. of images, based on color distributions of images, based on background parameters of images, etc.). In some embodiments, a user may also manually re-order images included in a stack (e.g., excluding or including the base image). Furthermore, in some embodiments, the electronic processor 12 may generate a user interface that includes a button or other selection mechanism that allows the user to randomly shuffle the images included in the stack (e.g., excluding the base image). The electronic processor 12 may be configured to visually display the “shuffling” of the images, such as by displaying images being rotated or spun into a new position within the stack.

In some embodiments, the electronic processor 12 compresses images included in the stack to generate a composite image. In these embodiments, the electronic processor 12 may be configured to generate the composite image such that the composite image may be subsequently un-compressed to provide access to the individual images used to create the composite image. For example, the composite image may be associated with metadata that identifies the individual images used in the composite image, the base image, an order of the individual images within the stack, transparency parameters (e.g., a transparency curve) applied to the individual images within the stack, and any other adjustments made to the composite image or underlying individual images that would be needed to un-compress the composite image. Accordingly, this functionality may be used to archive images by creating a single image file that includes or represents multiple image files.

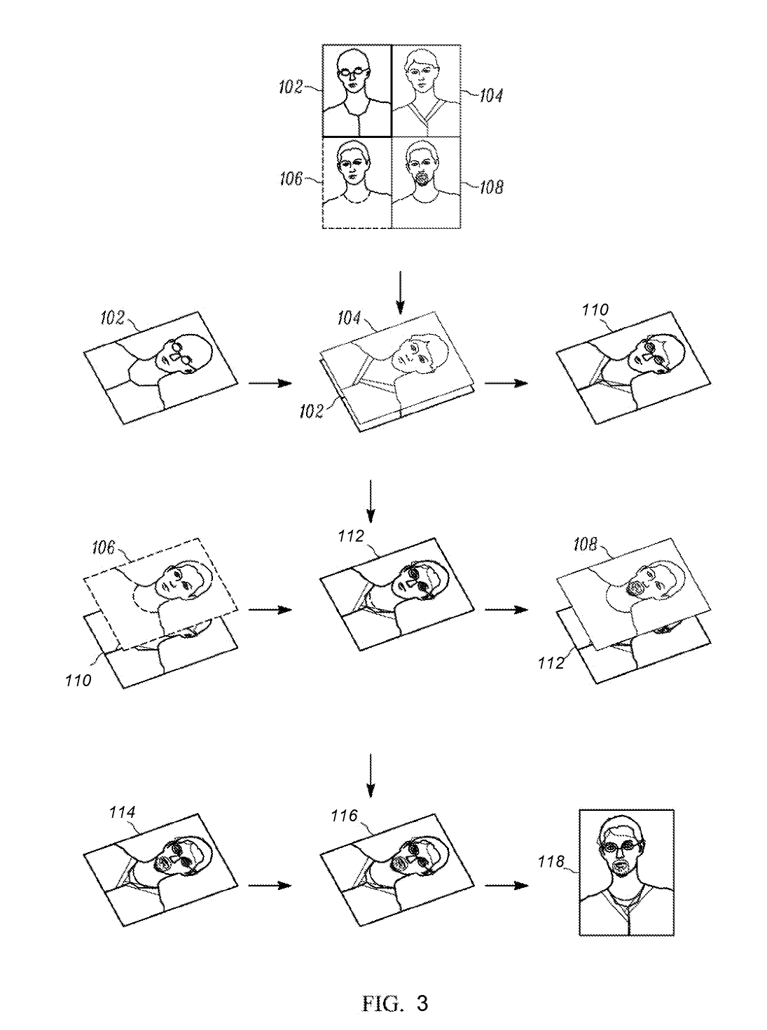

FIG. 3 illustrates four example images 102, 104, 106, and 108 used to generate a composite image according to the method 20. As illustrated in FIG. 3, the images 102, 104, 106 and 108 include at least one portrait of a subject, and the image 102 is the base image. Accordingly, the electronic processor 12 is configured to align and layer the image 104 on top of the base image 102 and adjust the transparency parameter of the image 104 to generate a first composite image 110 as described above. After generating the first composite image 110, the electronic processor 12 is configured to align and layer the image 106 on top of the first composite image 110 and adjust the transparency parameter of the image 106 to generate a second composite image 112 as described above.

Similarly, after generating the second composite image 112, the electronic processor 12 is configured to align and layer the image 108 on top of the second composite image 112 and adjust the transparency parameter of the image 108 to generate a third composite image 114 as described above. As illustrated in FIG. 3, in some embodiments, the electronic processor 12 processes the third composite image 114. For example, the electronic processor 12 may crop the third composite image 114, contrast adjust the third composite image 114, or perform a combination thereof to generate an adjusted composite image 116. The electronic processor 12 may then apply a radial filter to the adjusted composite image 116 to generate a completed composite image 118. As illustrated in FIG. 3, the radial filter may generate a vignette (e.g., a portrait that fades into its background without a definite border). The vignette may focus a user's attention on the aligned objects as compared to background features or other features included in the plurality of images that may not be part of the subject or aligned and, thus, may be distracting to a user.

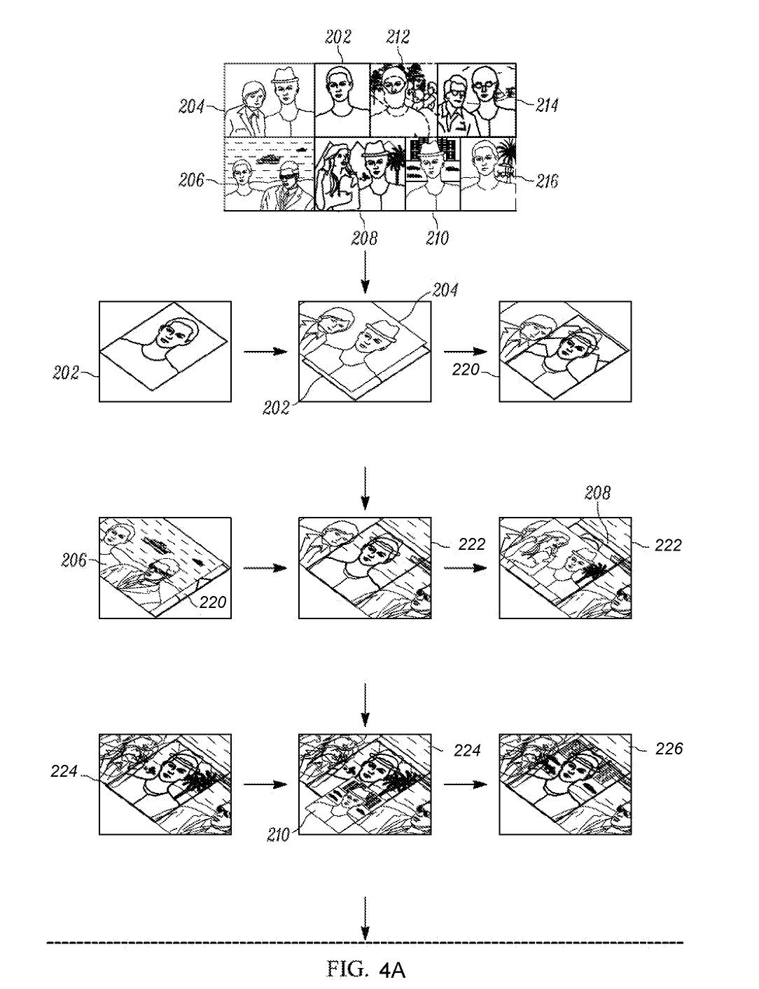

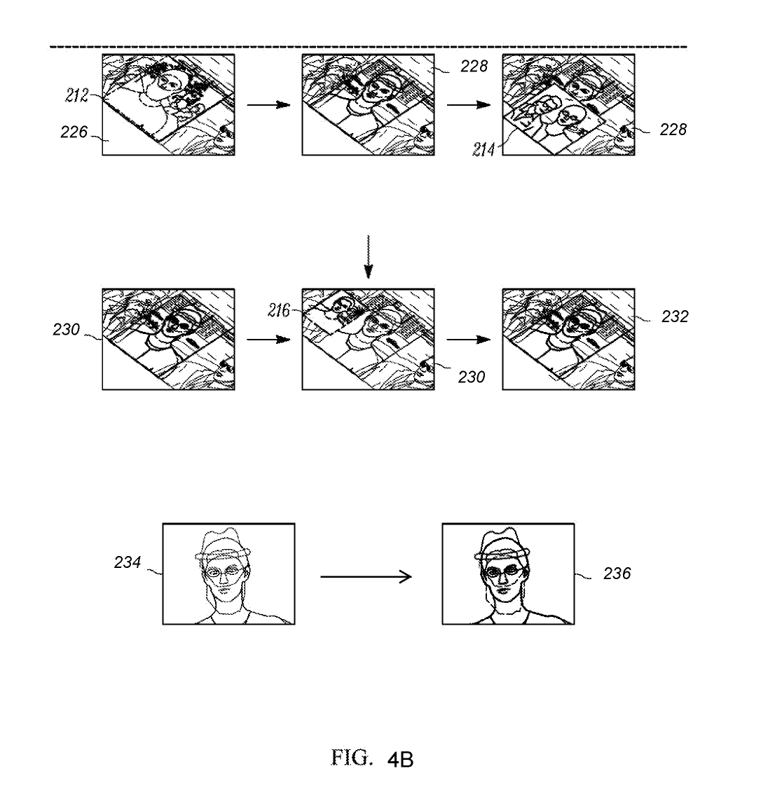

FIGS. 4A-B similarly illustrate eight example images 202, 204, 206, 208, 210, 212, 214, and 216 used to generate a composite image according to the method 20. As illustrated in FIG. 4A, the images 202, 204, 206, 208, 210, 212, 214, and 216 include at least one portrait of a subject, and image 202 is the base image. Accordingly, the electronic processor 12 is configured to align and layer the image 204 on top of the base image 202 and adjust the transparency parameter of the image 104 to generate a first composite image 220 as described above. After generating the first composite image 220, the electronic processor 12 is configured to align and layer the image 206 on top of the first composite image 220 and adjust the transparency parameter of the image 206 to generate a second composite image 222 as described above.

As illustrated in FIGS. 4A-B, the electronic processor 12 aligns and layers the image 208 on the second composite image 222 to generate a third composite image 224, aligns and layers the image 210 on the third composite image 224 to generate a fourth composite image 226, aligns and layers the image 212 on the fourth composite image 226 to generate a fifth composite image 228, aligns and layers the image 214 on the fifth composite image 228 to generate a sixth composite image 230, and aligns and layers the image 216 on the sixth composite image 230 to generate a seventh composite image 232. As described above, in some embodiments, the electronic processor 12 may process (e.g., crop, contrast adjust, filter, etc.) the seventh composite image 232. For example, the electronic processor 12 may crop the seventh composite image 232, contrast adjust the seventh composite image 232, or perform a combination thereof to generate an adjusted composite image 234. The electronic processor 12 may then apply a radial filter to the adjusted composite image 234 to generate a completed composite image 236.

Thus, embodiments of the invention provide methods and systems for generating a composite image from a plurality of images, wherein the composite image represents a view through the plurality of images stacked and aligned to a base image with regard to one or more objects (e.g., facial features) included in the base image. A transparency parameter of each image included the stack (e.g., with the exception of the base image) is adjusted to make the base image (or at least a portion thereof) viewable through the stack of images. It should be understood that the subjects included in the stack of images may include the same subject or a group of subjects, such as members of a family or another set of related or unrelated subjects.

Various features and advantages of embodiments of the invention are set forth in the following claims.

What is claimed is:

1. A method of generating a composite image, the method comprising:
receiving, with an electronic processor, a plurality of images;
selecting, with the electronic processor, a base image from the plurality of images, the base image including a base object;
generating, with the electronic processor, a stack of images by layering a first image included in the plurality of images on top of the base image, the first image including a first object;
aligning, with the electronic processor, the first object with the base object;
adjusting, with the electronic processor, a transparency parameter of at least one of the first image and the base image to make the base image viewable through the first image; and
combining, with the electronic processor, the base image and the first image to generate the composite image, the composite image representing a view of the stack of images from a top of the stack of images to the base image.

2. The method of claim 1, wherein selecting the base image includes selecting the base image based on metadata associated with each of the plurality of images.

3. The method of claim 1, wherein selecting the base image includes selecting the base image based on a timestamp associated with the base image.

4. The method of claim 1, wherein aligning the first object with the base object includes aligning a first facial feature of a first subject included in the first image with a base facial feature of a base subject included in the base image.

5. The method of claim 4, wherein aligning the first facial feature of the first subject included in the first image with the base facial feature of the base subject included in the base image includes aligning a first eye position of the first subject with a base eye position of the base subject.

6. The method of claim 1, wherein aligning the first object with the base object includes matching at least one dimension of the first object with at least one dimension of the base object.

7. The method of claim 1, wherein aligning the first object with the base object includes performing at least one selected from a group consisting of rotating the first image, rotating the base image, resizing the first image, resizing the base image, re-positioning the first image with respect to the base image, and re-positioning the base image with respect to the first image.

8. The method of claim 1, wherein adjusting the transparency parameter includes generating a random number using a random number generator and adjusting the transparency parameter based on the random number.

9. The method of claim 8, further comprising generating a preview of the composite image based on the first random number, generating a second random number using the random number generator, and re-adjusting the transparency parameter based on the second random number.

10. The method of claim 9, further comprising automatically determining whether to generate the second random number based on the preview of the composite image.

11. The method of claim 9, further comprising receiving user input requesting generation of the second random number based on the preview of the composite image.

12. The method of claim 1, wherein adjusting the transparency parameter including adjusting the transparency parameter based on a position of the first image within the stack of images.

13. The method of claim 1, wherein adjusting the transparency parameter includes adjusting the transparency parameter based on a number of images included in the stack of images.

14. The method of claim 1, wherein adjusting the transparency parameter includes adjusting the transparency parameter based on a characteristic of the at least one of the plurality of images, wherein the characteristic includes at least one selected from a group consisting of brightness, sharpness, and contrast.

15. The method of claim 1, further comprising automatically selecting the plurality of images by receiving a candidate image, determining whether the candidate image includes the base object, and, when the candidate image includes the base object, including the candidate image in the plurality of images.

16. The method of claim 15, further comprising displaying the candidate image on a display device for approval prior to adding the candidate image to the plurality of images.

17. The method of claim 1, wherein aligning the first object with the base object includes:
determining a base coordinate of at least a portion of the base object included in the base image defined as a pixel location within the base image;
converting the base coordinate to a coordinate system based on a display device;
determining a first coordinate of at least a portion of the first object included in the first image defined as a pixel location within the base image;
converting the first coordinate to the coordinate system based on the display device; and
adjusting the first image based on a comparison of the base coordinate and the first coordinate.

18. The method of claim 1, wherein adjusting the transparency parameter includes:
defining a transparency curve for the stack of images, the transparency curve plotting transparency parameters for positions of images within the stack of images.

19. The method of claim 18, wherein defining the transparency curve includes at least one of receiving a manually-defined transparency curve and receiving a predetermined transparency curve from a memory.

20. The method of claim 18, further comprising sharing the transparency curve for use with a second plurality of images.

21. An image processing system comprising:
an electronic processor configured to
receive a plurality of images,
receive a base image including a base object,
stack each of the plurality of images on top of the base image to generate a stack of images,
align an object included in each of the plurality of images with the base object,
adjust a transparency parameter of each of the plurality of images to make the base image viewable through each of the plurality of images, and
combine the base image and the plurality of images to generate a composite image, the composite image representing a view of the stack of images from a top of the stack of images to the base image.
